(19) United States
(12) Patent Application Publication
(10) Pub. No.: US 2026/0249702 A1
(43) Pub. Date: Aug. 27, 2026

(54) ON-BOARD ELECTRICAL SYSTEM FOR A VEHICLE

(71) Applicant: HELLA GMBH & CO. KGAA, Lippstadt (DE)

(72) Inventor: Thomas Schmitz, Lippstadt (DE)

(21) Appl. No.: 19/542,108

(22) Filed: Feb. 17, 2026

(30) Foreign Application Priority Data
Feb. 21, 2025 (DE) 102025106690.6

(51) Int. Cl. B60L 3/04; B60L 1/00; B60L 58/18

(52) U.S. Cl. CPC B60L 3/04; B60L 1/00; B60L 58/18; B60L 2210/10

(57) ABSTRACT

The invention relates to an on-board electrical system for a vehicle. The on-board electrical system includes: a first main battery for supplying a main load with electrical energy; a second main battery to supply the main load with electrical energy; a first DC/DC converter for supplying electrical energy from the first main battery to a low-voltage load; a second DC/DC converter for providing electrical energy from the second main battery to the low-voltage load; and an auxiliary battery for supplying the low-voltage load with electrical energy, wherein the on-board electrical system is interconnected in such a way that at least two redundant sub-networks are formed in order to provide fail-safe protection when supplying the low-voltage load.

### CROSS-REFERENCE TO RELATED APPLICATIONS

This application claims the benefit of German Patent Application No. 10-2025-106-690.6, filed Feb. 21, 2025, the disclosure of which is incorporated by reference in its entirety.

### FIELD OF THE INVENTION

The invention relates to an on-board electrical system for a vehicle. The invention further relates to a corresponding vehicle having a corresponding on-board electrical system and to advantageous uses of the on-board electrical system.

### BACKGROUND OF THE INVENTION

Modern vehicles, such as hybrid vehicles or electric vehicles, have increasingly higher levels of automation. As the level of automation increases, right up to autonomous vehicles, it is relevant to safety to provide redundancies and failure safety for the power supply of safety-critical functions.

Known on-board electrical systems with redundancies are associated with a high, often doubled, number of components (e.g., 2 converters and 2 LV batteries, or 2 large converters designed for high peak power and therefore expensive, as well as an additional converter optimized for low power), require a large installation space, and result in high costs. Furthermore, the functionality of known on-board electrical systems remains partially critical or limited.

### SUMMARY OF THE INVENTION

The object of the invention is to overcome at least one of the disadvantages described above, at least in part. In particular, it is an object of the invention to provide a safe on-board electrical system, which has a simple design, requires few components, which has cost-effective components with a simple design (e.g., for reduced power, e.g., rated power levels of energy suppliers), which can be operated safely and reliably, which has built-in safety mechanisms, which can react flexibly to different faults in the network and/or in components, which can provide safe and reliable redundancies in the event of a fault and which enables improved advantages in normal operation, e.g., with regard to component protection and stable operation. Furthermore, it is an object of the invention to provide a corresponding vehicle with a corresponding on-board electrical system and advantageous uses of the on-board electrical system.

The present invention provides an on-board electrical system for a vehicle with the features of the claimed or otherwise disclosed embodiments. Furthermore, the invention provides a corresponding vehicle with a corresponding on-board electrical system and advantageous uses of the on-board electrical system with the features of the further claimed or otherwise disclosed embodiments. In this context, features and details described in connection with the different embodiments and/or aspects of the invention naturally also apply in connection with the other embodiments and/or aspects and vice versa, such that reference may always be made reciprocally with regard to the disclosure of the individual embodiments and/or aspects of the invention.

According to the first aspect, the present invention provides an on-board electrical system for a vehicle, in particular, a hybrid vehicle or an electric vehicle, preferably an automated or autonomous vehicle. The on-board electrical system includes: a first main battery, e.g., a high-voltage battery, such as a 400V battery, or a 48V battery, for supplying a main load, e.g., an electric motor or an E-Maische, with electrical energy; a second main battery, e.g., a high-voltage battery, such as a 400V battery or a 48V battery, to supply the main load with electrical energy; a first DC/DC converter for supplying electrical energy from the first main battery to a low-voltage load; a second DC/DC converter to provide electrical energy from the second main battery to the low-voltage load; and one, in particular only one, auxiliary battery, e.g., a low-voltage battery, such as a 12V battery, for supplying the low-voltage load with electrical energy, wherein the on-board electrical system is interconnected in such a way (e.g., by means of a cross-interconnection) that at least two redundant sub-networks are formed in order to provide fail-safe protection when supplying the low-voltage load.

Two converters and one (in particular only one) low-voltage battery can be used to create a safe on-board electrical system. The advantages of the low-voltage battery can be utilized in the form of short-term peak power. The converters, therefore, need to be designed for the rated power and not for the peak power. This can lead to considerable cost savings in terms of component design (in particular the design of converters) and the number of components (in particular the number of redundant components, such as a second low-voltage battery). At the same time, the advantageous interconnection of the components means that individual faults in the respective components and/or in the respective sub-networks can be covered safely and reliably. The arrangement of the components (reduced in number), their simple and cost-effective design, and the advantageous interconnection according to the invention can provide an efficient, safe, and robust, if not technically best, solution for safe on-board electrical systems.

Furthermore, there are also advantages at the vehicle level in terms of cost reduction and/or weight reduction in the design of components, particularly in the design of converters, and in terms of a reduction in the number of components and their weight, as only one low-voltage battery is installed.

The on-board electrical system can further provide improved and extended functionality.

Advantageously, the on-board electrical system is interconnected in such a way that the low-voltage load can be supplied with electrical energy via: the auxiliary battery and the first DC/DC converter; and/or the auxiliary battery and the second DC/DC converter; and/or the first DC/DC converter and the second DC/DC converter, in order to obtain the required power to the low-voltage load. In this way, the low-voltage load can be safely and reliably supplied with electrical energy in the event of various component faults, whether in the first DC/DC converter, in the second DC/DC converter, or in the auxiliary battery, and/or in the event of network faults, e.g., in the first sub-network or in the second sub-network. If, for example, the first DC/DC converter has a rated power of 250 A, the second DC/DC converter has a rated power of 250 A, and the auxiliary battery has a charging capacity of 20 Ah, then it can be ensured that the load can safely receive up to 500 A, even if one of the above-mentioned components fails or a network fault occurs, e.g., a cable break, etc., two remaining components can still provide the required power.

One advantage can be that the on-board electrical system is interconnected in such a way that in the event of a fault in an affected sub-network, the affected sub-network can disconnect itself. Affected switches in the faulty sub-network can disconnect the sub-network independently and safely. At the same time, it can be ensured that the remaining sub-network can form a safe and reliable redundancy.

One advantage may be that the on-board electrical system is interconnected in such a way that in the event of a fault in an affected component, the affected electronic component, e.g., the first DC/DC converter or the second DC/DC converter, and/or in the event of a fault in the affected auxiliary battery, the affected auxiliary battery can disconnect itself, in particular from both sub-networks. In this case, affected switches on the faulty component can disconnect the component independently and safely. At the same time, it can be ensured that the remaining components can form a safe and reliable redundancy.

It may further be provided that the on-board electrical system has two switches for the first DC/DC converter. The two switches can advantageously be used to disconnect the first DC/DC converter in the event of a fault. At the same time, one switch can be used to disconnect a first sub-network in the event of a fault, and the other switch can be used to disconnect a second sub-network in the event of a fault.

Furthermore, it may be provided that the on-board electrical system has two switches for the second DC/DC converter. The two switches can advantageously be used to disconnect the second DC/DC converter in the event of a fault. At the same time, one switch can be used to disconnect a first sub-network in the event of a fault, and the other switch can be used to disconnect a second sub-network in the event of a fault.

Furthermore, it may be provided that the on-board electrical system has two switches for the auxiliary battery. The two switches can advantageously be used to disconnect the auxiliary battery in the event of a fault. At the same time, one switch can be used to disconnect a first sub-network in the event of a fault, and the other switch can be used to disconnect a second sub-network in the event of a fault.

Furthermore, it may be advantageous if the on-board electrical system has such switches that are designed to detect at least one fault condition and to act like a fuse, e.g., comprising at least one of the following fault conditions: a component fault; a network fault; an overcurrent; a voltage level, e.g., comprising an overvoltage and/or an overvoltage; an incorrect current direction, etc.

Switches can thus be used to provide built-in safety mechanisms that can flexibly react to different faults in the network and/or in components, provide safe and reliable redundancies in the event of a fault, and enable improved and/or extended functionality in normal operation.

For example, it is conceivable that the on-board electrical system has integrated switches, e.g., in the respective power electronics. In this way, an integral design can be made possible, and further advantages in terms of installation space and weight can arise.

Advantageously, the first DC/DC converter, the second DC/DC converter, and the auxiliary battery can each have power electronics, which can, for example, have integrated switches, preferably two per component in each case. This ensures that the components, individually or the sub-networks as a whole, can be flexibly switched off or on.

It is also conceivable that the on-board electrical system has individual switches, e.g., each with its own electronics. In this way, existing components can be used, which can be interconnected to form an advantageous on-board electrical system in the sense of the present invention.

According to the second aspect, the present invention provides: a vehicle, in particular a hybrid vehicle or an electric vehicle, preferably an automated to an autonomous vehicle, having an on-board electrical system, which can be constructed as described above, for supplying safety-relevant driver assistance functions on the low-voltage load. The vehicle can be used to achieve the same advantages as described above in connection with the on-board electrical system.

The safety-relevant driver assistance functions can have at least one longitudinal control function and/or at least one lateral control function, for example: an emergency brake assist system; a lane keeping assist system; a distance keeping assist system; a speed limit assist system; a reversing assist system; an adaptive brake light system; an accident data recorder; and/or a driver fatigue detection system.

In this way, safety during vehicle operation can be significantly increased. In addition, personal safety and road safety can be guaranteed in this way.

According to the third aspect, the present invention provides use of an on-board electrical system, which can be designed as described above, to provide at least one safety function in order to: continue to operate the vehicle safely; operate the vehicle safely during a transitional period until a driver can take over vehicle control; bring the vehicle safely to a standstill, e.g., on a roadside; and/or transmit an emergency call.

In this way, the reliability of the on-board electrical system can be guaranteed.

According to the fourth aspect, the present invention provides: use of an on-board electrical system, which can be designed as described above, to absorb power peaks by means of the auxiliary battery; and/or to provide medium loads by means of electronic components, e.g., the first DC/DC converter or the second DC/DC converter, preferably evenly distributed.

In this way, improved and/or extended functionality of the on-board electrical system can be ensured, with increased component protection and the advantages of their design.

### BRIEF DESCRIPTION OF THE DRAWING

The invention is explained in more detail below, with reference to the accompanying drawing. In the drawing:

FIG. 1 is a proposed on-board electrical system.

### DETAILED DESCRIPTION

According to the first aspect, the present invention provides:
an on-board electrical system 100 for a vehicle F, which may, for example, have a topology of a hybrid vehicle or an electric vehicle, and which may preferably be designed as an automated to autonomous vehicle.

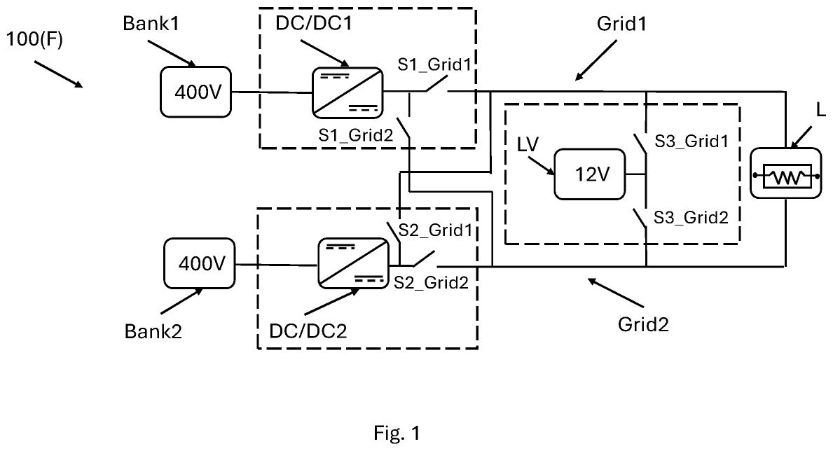

As illustrated in FIG. 1, the proposed on-board electrical system 100 has the following components: a first main battery Bank1, e.g., a high-voltage battery, such as a 400V battery, or a 48V battery, for supplying a main load, e.g., an electric motor or an E-Maische, with electrical energy; a second main battery Bank2, e.g., a high-voltage battery, such as a 400V battery, or a 48V battery, to supply the main load with electrical energy; a first DC/DC converter DC/DC1 for supplying electrical energy from the first main battery Bank1 to a low-voltage load L; a second DC/DC converter DC/DC2 for supplying electrical energy from the second main battery Bank2 to the low-voltage load L; and one, in particular only one, auxiliary battery LV, e.g., a low-voltage battery, such as a 12V battery, for supplying the low-voltage load L with electrical energy.

According to the invention, the on-board electrical system 100 is (cross-)interconnected in such a way that at least two redundant sub-networks Grid1, Grid2 are formed, in order to provide fail-safe protection when supplying the low-voltage load L.

Two DC/DC converters DC/DC1 and DC/DC2 and an auxiliary battery LV (in particular only one) can be used to provide a safe on-board electrical system 100.

The advantages of the auxiliary battery LV lie in its ability to absorb short-term peak power.

The DC/DC converters DC/DC1 and DC/DC2, therefore, only need to be designed for the rated power and not for the peak power.

This leads to considerable cost and installation space savings in terms of component design and the number of components.

At the same time, the advantageous interconnection of the DC/DC1, DC/DC2 and LV components means that individual faults in the respective components and/or in the respective Grid1 and Grid2 sub-networks can be covered safely and reliably.

As further illustrated in FIG. 1, the low-voltage load L can thus be supplied with electrical energy via the auxiliary battery LV and the first DC/DC converter DC/DC1, and/or the auxiliary battery LV and the second DC/DC converter DC/DC2, and/or the first DC/DC converter DC/DC1, and the second DC/DC converter DC/DC2.

In this way, the low-voltage load L can be safely and reliably supplied with electrical energy in the event of various component faults, be it in the first DC/DC converter DC/DC1, in the second DC/DC converter DC/DC2, or in the auxiliary battery LV, and/or in the event of network faults, e.g., in the first sub-network Grid1 or in the second sub-network Grid 2.

If, for example, the first DC/DC converter DC/DC1 has a rated power of 250 A, the second DC/DC converter has a rated power of 250 A, and the auxiliary battery has a charging capacity of 20 Ah, then it can be ensured that the load can safely receive up to 500 A, even if one of the above-mentioned components DC/DC1, DC/DC2, or LV fails or a network fault occurs, e.g. a cable break, etc., two remaining components can still provide the required power of 500 A, for example.

As illustrated in FIG. 1 by the arrangement of the switches S1_Grid1, S1_Grid2, S2_Grid1, S2_Grid2, S3_Grid1, and S3_Grid2, the affected sub-network Grid1, Grid2 can disconnect itself as a whole in the event of a fault in an affected sub-network Grid1, Grid2. In this case, affected switches (e.g., S1_Grid1, S2_Grid1, S3_Grid1, or S1_Grid2, S2_Grid2, S3_Grid2) in the faulty sub-network (e.g., Grid1 or Grid2) can independently and safely disconnect the respective sub-network (e.g., Grid1 or Grid2).

As illustrated in FIG. 1 by the arrangement of the switches S1_Grid1, S1_Grid2, S2_Grid1, S2_Grid2, S3_Grid1, and S3_Grid2, in the event of a fault in one (e.g., only one) affected electronic component, the affected component, e.g., the first DC/DC converter DC/DC1 or the second DC/DC converter DC/DC2, can disconnect itself, in particular from both sub-networks Grid1, Grid2.

At the same time, in the event of a fault in the affected auxiliary battery LV, the affected auxiliary battery LV can disconnect itself, in particular from both sub-networks Grid1 and Grid2.

As shown schematically in FIG. 1, affected switches (e.g. S1_Grid1, S1_Grid2) on the faulty component (e.g. DC/DC1) can disconnect the affected component (e.g. DC/DC1) independently and safely.

Firstly, it can be seen from FIG. 1 that the on-board electrical system 100 can have two switches S1_Grid1, S1_Grid2 for the first DC/DC converter DC/DC1. The two switches S1_Grid1, S1_Grid2 can advantageously be used to disconnect the first DC/DC converter DC/DC1 in the event of a fault. At the same time, one switch S1_Grid1 can be used to disconnect a first sub-network Grid1 in the event of a fault, and the other switch S1_Grid2 can be used to disconnect a second sub-network Grid2 in the event of a fault.

Secondly, it can be seen from FIG. 1 that the on-board electrical system 100 can have two switches S2_Grid2, S2_Grid1 for the second DC/DC converter DC/DC2. The two switches S2_Grid2, S2_Grid1 can advantageously be used to disconnect the second DC/DC converter DC/DC2 in the event of a fault. At the same time, one switch S2_Grid1 can be used to disconnect a first sub-network Grid1 in the event of a fault, and the other switch S2_Grid2 can be used to disconnect a second sub-network Grid2 in the event of a fault.

Furthermore, it can be seen from FIG. 1 that the on-board electrical system 100 can have two switches S3_Grid1, S3_Grid2 for the auxiliary battery LV. The two switches S3_Grid1, S3_Grid2 can advantageously be used to disconnect the auxiliary battery LV in the event of a fault. At the same time, one switch S3_Grid1 can be used to disconnect a first sub-network Grid1 in the event of a fault, and the other switch S3_Grid2 can be used to disconnect a second sub-network Grid2 in the event of a fault.

The switches S1_Grid1, S1_Grid2, S2_Grid1, S2_Grid2, S3_Grid1, and S3_Grid2 can advantageously be designed to detect at least one fault condition and act like a fuse, for example: a component fault; a network fault; an overcurrent; a voltage level, e.g., comprising an overvoltage and/or an overvoltage; and/or an incorrect current direction.

This allows built-in safety mechanisms to be provided that can react flexibly to different faults in the on-board electrical system 100 and/or in components DC/DC1, DC/DC2, LV.

The switches S1_Grid1, S1_Grid2, S2_Grid1, S2_Grid2, S3_Grid1, and S3_Grid2 can, for example, be integrated in the respective power electronics of a corresponding component DC/DC1, DC/DC2, LV.

It may be advantageous if the first DC/DC converter DC/DC1, the second DC/DC converter DC/DC2, and the auxiliary battery LV each have power electronics which, for example, have integrated switches S1_Grid1, S1_Grid2, S2_Grid1, S2_Grid2, S3_Grid1, and S3_Grid2, preferably two per component DC/DC1, DC/DC2, LV in each case.

However, the switches S1_Grid1, S1_Grid2, S2_Grid1, S2_Grid2, S3_Grid1, and S3_Grid2 can also be designed as individual switches, e.g., each with its own electronics.

A corresponding vehicle F with a corresponding on-boarding electrical system 100 and advantageous uses of the on-board electrical system 100 represent further aspects of the invention.

The foregoing description of the figures describes the present invention solely by way of examples. It is understood that individual features of the embodiments can be freely combined with one another, provided this makes technical sense, without departing from the scope of the present invention

### LIST OF REFERENCE SYMBOLS

100 on-boarding electrical system
Bank1 first main battery
Bank2 second main battery
DC/DC1 first converter
DC/DC2 second converter
LV auxiliary battery
L low-voltage load
Grid1 first sub-network
Grid2 second sub-network
F vehicle
S1_Grid1 switch
S1_Grid2 switch
S2_Grid1 switch
S2_Grid2 switch
S3_Grid1 switch
S3_grid2 Switch

The above description is that of current embodiments of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. An on-board electrical system for a vehicle such as a hybrid vehicle or an electric vehicle, comprising:
a first main battery for supplying a main load with electrical energy;
a second main battery for supplying the main load with electrical energy;
a first DC/DC converter for supplying electrical energy from the first main battery to a low-voltage load;
a second DC/DC converter for supplying electrical energy from the second main battery to the low-voltage load; and
an auxiliary battery for supplying the low-voltage load with electrical energy,
wherein the on-board electrical system is interconnected in such a way that at least two redundant sub-networks are formed in order to provide fail-safe protection when supplying the low-voltage load.

2. The on-board electrical system according to claim 1, wherein the on-board electrical system is interconnected in such a way that the low-voltage load can be supplied with electrical energy via:
the auxiliary battery and the first DC/DC converter;
the auxiliary battery and the second DC/DC converter; or
the first DC/DC converter and the second DC/DC converter,
in order to obtain the required power to the low-voltage load.

3. The on-board electrical system according to claim 1, wherein the on-board electrical system is interconnected in such a way that in the event of a fault in an affected redundant sub-network of the at least two redundant sub-networks, the affected redundant sub-network can disconnect itself.

4. The on-board electrical system according to claim 1,
wherein the on-board electrical system is interconnected in such a way that, in the event of a fault in an affected electronic component, the affected electronic component can disconnect itself from the at least two redundant sub-networks, or
wherein the on-board electrical system is interconnected in such a way that, in the event of a fault in an affected auxiliary battery, the affected auxiliary battery can disconnect itself from the at least two redundant sub-networks.

5. The on-board electrical system according to claim 1, further comprising two switches for the first DC/DC converter.

6. The on-board electrical system according to claim 1, further comprising two switches for the second DC/DC converter.

7. The on-board electrical system according to claim 1, further comprising two switches for the auxiliary battery.

8. The on-board electrical system according to claim 1, further comprising:
a plurality of switches configured to detect at least one fault condition and to act like a fuse, wherein the at least one fault condition includes:
a component fault;
a network fault;
an overcurrent;
a voltage level such as an overvoltage or an overvoltage; or
an incorrect current direction.

9. The on-board electrical system according to claim 1, further comprising integrated switches.

10. The on-board electrical system according to claim 1, wherein the first DC/DC converter, the second DC/DC converter, and the auxiliary battery each have power electronics.

11. The on-board electrical system according to claim 1, further comprising individual switches.

12. A vehicle, the vehicle comprising:
the on-board electrical system according to claim 1, wherein the on-board electrical system supplies safety-relevant driver assistance functions to the low-voltage load.

13. The vehicle according to claim 12, wherein the safety-relevant driver assistance functions have at least one longitudinal control function or at least one lateral control function, wherein the safety-relevant driver assistance functions include:
an emergency brake assist system;
a lane keeping assist system;
a distance keeping assist system;
a speed limit assist system;
a reversing assist system;
an adaptive brake light system;
an accident data recorder; or
a driver fatigue detection system.

14. The vehicle according to claim 12, wherein the on-board electrical system is configured to provide at least one safety function, the at least one safety function configured to enable a driver of the vehicle to: continue to operate the vehicle safely; operate the vehicle safely during a transitional period until the driver can take over vehicle control; bring the vehicle safely to a standstill; or transmit an emergency call.

15. The on-board electrical system according to claim 1, wherein the on-board electrical system is configured to absorb power peaks by means of the auxiliary battery, or to provide medium loads by means of electronic components, which may include the first DC/DC converter or the second DC/DC converter.
